(19) United States
(12) Patent Application Publication
(10) Pub. No.: US 2008/0047587 A1
(43) Pub. Date: Feb. 28, 2008

(54) Method and apparatus for cleaning tanks and other containers

(76) Inventor: David M. Ball, Lafayette, LA (US)

Correspondence Address: Ted M. Anthony;Suite 1600, 600 Jefferson Street, Lafayette, LA, 70501, US

(21) Appl. No.: 11/507,780

(22) Filed: Aug. 22, 2006

(51) Int. Cl. B08B 9/00; B08B 3/00; B08B 3/12

(52) U.S. Cl. 134/22.1; 134/184; 134/198; 134/166 R; 134/34

(57) ABSTRACT

A closed-loop system for cleaning tanks and other enclosures utilizing adjustably mounted nozzles for spraying water, other wash fluid and/or beneficial chemical additive within the tanks or other enclosures to be cleaned. Effluent wash fluid leaving a tank is directed to a separator unit for separation of liquids and solids. Solids are disposed of or otherwise removed, while recovered liquids are directed for re-use. Exposure of personnel to the inside of such tanks or other enclosures to be cleaned is minimal.

### CROSS REFERENCES TO RELATED APPLICATIONS

None

### FEDERALLY SPONSORED RESEARCH

Not Applicable

### SEQUENCE LISTING OF PROGRAM

Not Applicable

### BACKGROUND OF INVENTION

1. Field of Invention

The present invention pertains to a method and apparatus for cleaning tanks and other containers including, but not necessarily limited to, storage tanks on drilling rigs and marine vessels. More particularly, the present invention pertains to a method and apparatus for cleaning tanks, including the interior surfaces of such tanks, containing solids-laden fluids such as drilling muds and the like.

2. Description of Related Art

Tanks, containers and other similar enclosures are commonly used to store liquids in any number of different applications. Tanks of varying sizes and shapes are frequently used to store liquids in connection with numerous industries including, but not necessarily limited to, the oil and gas industry. Such tanks are especially prevalent in the offshore oil and gas industry, in particular, where they are often used to store different types of fluids on boats and/or drilling rigs.

In many cases, tanks on boats and drilling rigs are used to store and/or transport drilling fluids. Such drilling fluids often contain chemicals and/or other additives designed adjust or control certain characteristics of said fluids. Common drilling fluid additives include gelling agents (e.g., colloidal solids and/or emulsified liquids), weighting materials (e.g., barite and/or bentonite, etc.), and/or other chemicals which are used to maintain fluid properties within desired parameters. Further, although drilling fluids have historically been water-based, improved results have been obtained using oil-based or synthetic-based drilling fluids, especially in severe drilling environments. Many of these additives, as well as oil-based and synthetic-based drilling fluids, can be harmful to personnel and the environment.

Different stages of the drilling process may require different types of drilling fluids having different characteristics. In such cases, the limited tank capacity of boats and/or drilling rigs necessitates using the same tanks to store such different drilling fluids. However, because such different types of drilling fluids may not be compatible with one another, it is frequently necessary to clean such tanks before switching the fluids to be stored in such tanks.

The process of cleaning tanks can often prove to be difficult, expensive and time consuming. Such cleaning can be especially challenging when solids are permitted to drop out of suspension. In such cases, solids are often deposited in the tanks, forming hardened layers at or near the bottom of such tanks that cannot be simply drained from the tanks. Frequently, such deposited solids must be removed before interior surfaces of the tanks can be cleaned.

Personnel are often utilized to manually clean storage tanks on boats and drilling rigs. In such cases, personnel are required to physically climb inside the tanks and use water hoses, brushes and the like to clean the internal surfaces of such tanks. When hardened deposits of solids are present, such personnel are also often required to manually remove such deposits using shovels or other similar means while wearing personal protection equipment (“PPE”). This method of cleaning tanks can be very physically challenging, especially on hot days when temperatures inside the tanks can be extremely high (and ventilation within such tanks can be very poor). Further, this method of cleaning tanks raises safety concerns, because personnel inside the tanks are frequently exposed to drilling fluid residue, toxins and/or contaminants that may be present within such tanks.

Various automated tank cleaning devices have been developed in an attempt to eliminate the numerous problems associated with manual cleaning of tanks, such as tanks located on boats and/or drilling rigs. However, performance of such prior art cleaning devices has proven to be less than satisfactory, often because such prior art cleaning devices cannot adequately reach all areas of tanks to be cleaned and, further, most chemical compounds used with in connection with prior art automated cleaning devices are ineffective at removing solids from tanks being cleaned. Moreover, said prior art devices can be cumbersome, as well as difficult and expensive to operate.

Regardless of the method and/or apparatus used, virtually all prior art means of cleaning tanks utilize wash water or some other fluid(s) to wash drilling fluid residue, solids and/or other debris from the inner surfaces of such tanks. After being used, the wash water effluent or other fluid typically contains significant amounts of solids or other contaminants. As a result, such effluent typically cannot be dumped or otherwise disposed of where the tank is located due to environmental concerns. In most cases, in order to avoid environmental contamination and comply with applicable governmental regulations, such wash water or other effluent fluid must be transported to another location for offsite disposal. In order to accomplish such off-site disposal, the effluent must be loaded into boxes or other storage containers for transportation away from the rig, boat or other tank location. While this solution can be generally functional, it is not without significant problems.

One major problem associated with the off-site disposal of wash water effluent is increased cost. In most cases, large numbers of storage boxes or other portable containers must be rented or purchased in order to hold such effluent. Such added equipment and labor increases the costs associated with the tank cleaning process.

Another major problem associated with off-site disposal of wash water or other effluent is the use of valuable rig space. Space is at a premium on most drilling rigs, and particularly those that work in a marine environment. In most instances, storage boxes takes up a great deal of a rig's available work area. This additional equipment can present logistical and/or safety problems on many boats and rigs.

Another problem associated with off-site disposal of waste water or other effluent wash fluid is environmental impact. Such off-site disposal does not necessarily guarantee an overall reduction or elimination of environmental contamination. Boxes or other portable containers must be transported to a boat or rig, loaded with wash water or other effluent fluid, and thereafter moved to an off-site disposal facility. Trucks, vessels or other pollution-emitting means of transportation must typically be employed to transport said boxes to and from the boat or rig. As a result, the overall impact on the environment as a result of such offsite disposal can be significant.

Accordingly, there is a need for an efficient and effective automated system for cleaning tanks and/or similar enclosures, including tanks containing solids-laden fluids and/or hardened deposits of solids that have dropped from suspension. Such system should permit cleaning of entire tanks or other enclosures, and should minimize the need for personnel to physically enter such tanks or other enclosures. Further, such system should reduce the amount of effluent fluid generated as a result of the cleaning process.

### SUMMARY OF THE INVENTION

The present invention comprises a method and apparatus for cleaning tanks and other similar enclosures including, but not necessarily limited to, mud tanks situated in drilling rigs, work boats and the like.

The cleaning apparatus of the present invention comprises at least one sprayer nozzle beneficially mounted within a tank to be cleaned. Although said at least one nozzle can be mounted within such tank using any number of different methods, in the preferred embodiment said at least one nozzle is mounted to an internal surface of such tank using adjustable mounting means. Such adjustable mounting means can include, but are not necessarily limited to, one or more magnetic mounting brackets. Use of said at least one sprayer nozzle eliminates the need for personnel to enter a tank for prolonged periods. Rather, such personnel are typically only required to enter a tank in order to install, reposition and/or remove said at least one sprayer nozzle in such tank.

In the preferred embodiment, water mixed with a beneficial surfactant solution is discharged through said sprayer nozzle at high velocity in desired direction(s) within a tank to be cleaned in order to wash the interior surfaces of such tank. In most applications, it is beneficial to spray all internal surfaces of a tank. This can frequently be accomplished by moving or re-orienting the adjustable mounting means within a tank in order to aim said at least one sprayer nozzle at desired location(s) within such tank. Further, the spray head(s) of said at least one sprayer nozzle can also be interchanged in order to vary the aim or spray pattern of said at least one sprayer nozzle. In many instances, it is beneficial to employ at least one sprayer nozzle having a swivel configuration that will permit spraying in multiple directions.

Because high concentrations of barite and other deposited solids may be present on or near the base of a tank, said at least one sprayer nozzle can be oriented in a manner that would focus a spray pattern on the lower portion of tank. Use of adjustable mounting means, and/or sprayer nozzles that can be aimed, allow focused washing of certain portions of a tank (such as, for example, the base of a tank having a layer of deposited solids) in order to ensure effective cleaning of such tank. If desired, the aiming direction of said at least one spray nozzle can be controlled remotely by personnel located outside of a tank being cleaned. Additionally, the duration of spray time can also be focused for longer periods in certain portion(s) of a particular tank, if desired.

As water mixed with beneficial surfactant solution is sprayed inside a tank using said at least one sprayer nozzle, such water or other washing fluid can build up or accumulate inside such tank. Further, solids (such as, for example, barite, bentonite or other drilling fluid residue from the internal surfaces of the tank), can become suspended in such water or other washing fluid. Accordingly, in the preferred embodiment, a pump is placed within said tank in order to remove such accumulated water or other wash fluid, as well as any accompanying solids. In the preferred embodiment, such pump is ideally a high rate submergible pump capable of pumping relatively large volumes of water. Although such pump can be installed in any number of manners, in the preferred embodiment said pump is attached to a hose and suspended within the tank being cleaned. In the preferred embodiment, such pump is positioned at or near the base of the tank in order to beneficially draw from lower levels of the tank.

Water or other wash fluid, and any accompanying solids, are pumped from the tank and directed to a separator unit. In the preferred embodiment, said separator unit is a vessel having at least two compartments separated by at least one baffle assembly. Solids suspended in or otherwise carried by said effluent remain within at least one such compartment, while the water or other wash fluid passes to at least one other segregated compartment. Separated solids can be removed from the separator unit and loaded into boxes or other containers for disposal (or transportation to an off-site disposal facility).

Recovered water and/or other wash fluids are directed from the segregated compartment(s) of the separator unit into the tank being cleaned via said at least one sprayer nozzle. In this manner, such water and/or wash fluid is recycled and reused as part of a “closed-loop” system, thereby reducing the amount of water and/or wash fluids needed (as well as effluent that must transported to an off-site facility for disposal).

In the preferred embodiment, at least one chemical agent or other beneficial additive can be added to the water or other washing fluid to be sprayed within a tank to be cleaned. Such chemical agent(s) promote solids dropping out of suspension, thereby allowing solids and liquids to more readily separate within the separator unit, which in turn improves the overall performance of said separator unit.

As water or other wash fluid is cycled through the aforementioned process, effluent fluid pumped from the tank being cleaned carries progressively less solids. The longer that the process is allowed to continue, the cleaner a particular tank will become. Further, the effectiveness of the cleaning progress can be judged or evaluated—at least in part—by examining the effluent stream leaving such tank.

In the preferred embodiment of the present invention, water or other wash fluid is pumped via single skid-mounted unit containing all necessary pumps. Further, in the preferred embodiment, such skid-mounted unit contains necessary chemical additive pump(s), touch-up pressure washers, hydraulic units and/or similar equipment that may be needed or beneficial during the tank cleaning process. Additionally, at least one storage box can be provided to house and transport all required hoses on reels. Quick-connect connections are provided on outside of said box to connect to said hoses.

There are many advantages associated with the present invention including, but necessarily limited to: (1) improved cleaning performance and efficiency by at least 50% as compared to conventional manual cleaning methods; (2) reduced exposure of personnel to the inside of tanks being cleaned (as well as substances contained therein) by at least 80% compared to conventional manual cleaning methods; (3) reduction in waste water volumes generated as compared to conventional fluid chemical additives; (4) ease of handling of waste materials; and (5) ability to gauge cleaning progress in real time.

### BRIEF DESCRIPTION OF DRAWINGS

FIG. 1 depicts a schematic view of the cleaning apparatus of the present invention.

FIG. 2 depicts a side view of a sprayer device of the present invention.

FIG. 3 depicts a front view of an alternative embodiment of a sprayer device of the present invention.

FIG. 4 depicts a cut-away view of a submergible pump of the present invention.

FIG. 5 depicts a cut-away view of the separator unit of the present invention.

FIG. 6 depicts an overhead schematic view of a marine mobile cleaning apparatus of the present invention.

### DETAILED DESCRIPTION OF A PREFERRED EMBODIMENT

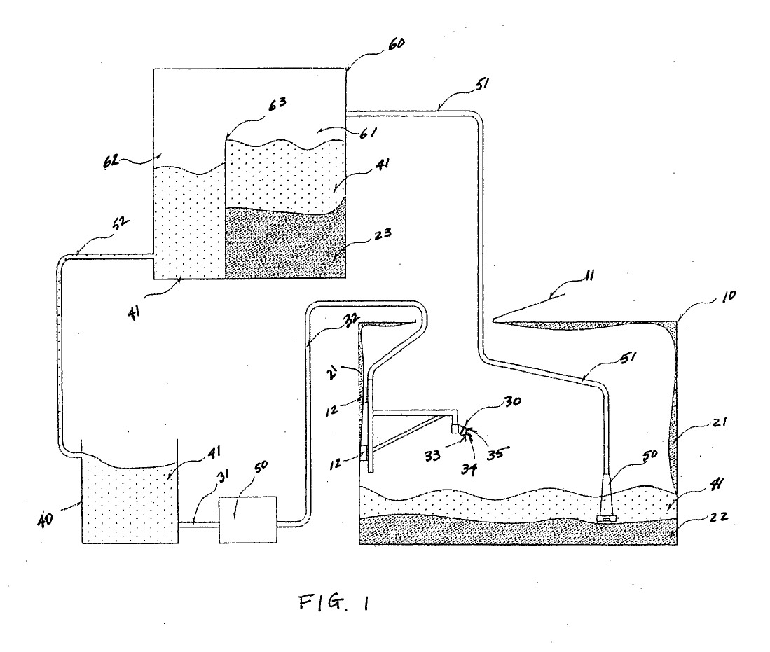

Referring to the drawings, FIG. 1 depicts a schematic view of the cleaning apparatus of the present invention. Tank 10, having access hatch 11, represents a storage tank to be cleaned. Although the present invention can be used to clean any number of tanks having different sizes, shapes and/or configurations, and containing any number of different fluids, tank 10 is described herein as a storage tank for drilling fluids and/or other solids-laden fluids, such as may be routinely encountered on boats and/ or drilling rigs. Tank 10 contains drilling fluid residue 21 on certain internal surfaces of tank 10, as well as hardened solids 22 deposited at or near the bottom of tank 10. However, such description is for illustration only and is not intended to limit the scope of the present invention to a particular application or type of tank/enclosure to be cleaned.

The cleaning apparatus of the present invention comprises at least one sprayer device 30 beneficially mounted within the confines of a tank 10. Although said sprayer device can be mounted within such tank using any number of different methods, in the preferred embodiment sprayer device 30 is mounted to an internal surface of tank 10 using adjustable magnetic mounts 12. Use of sprayer device 30 eliminates the need for personnel to enter tank 10 for prolonged periods. Rather, such personnel are typically only required to enter tank 10 in order to mount sprayer device 30 within tank 10 using magnetic mounts 12. Thereafter, such personnel must generally only enter tank 10 for purposes of repositioning sprayer device 30 within tank 10 to ensure proper cleaning, or to remove sprayer device 30 after the cleaning process is completed.

The cleaning process will be described herein as using water and a beneficially formulated chemical additive, such as a surfactant solution more fully described herein. However, it is to be observed that any number of different wash fluids other than water can be used to fit particular applications and conditions including, without limitation, the size and configuration of the tank to be cleaned, properties of debris to be encountered, etc. Moreover, any number of different beneficial chemical additives may be included with such wash fluids to improve the overall cleaning efficiency of the present invention. Referring to FIG. 1, wash water 41 is contained within reservoir 40, and flows through a conduit, such as hose 31, to pump unit 50. Wash water 41 is then pumped through a conduit, such as hose 32, into sprayer device 30. In the preferred embodiment, wash water 41 is discharged through nozzles of sprayer device 30 at high velocity in desired direction(s) within tank 10 in order to wash the interior surfaces of tank 10.

In most applications, it is beneficial to spray all internal surfaces of tank 10. As a result, it is frequently beneficial to move or reorient magnetic mounts 12 to different locations within tank 10 in order to beneficially aim the discharge from sprayer device 30 at desired location(s) within such tank 10. Further, in the preferred embodiment, sprayer device 30 has a swivelled head configuration having a plurality of nozzles 33, 34, and 35 that permit omnidirectional discharge of wash water 41. In the preferred embodiment, sprayer device 30 spins, thereby causing nozzles 33, 34 and 35 to point in multiple different directions.

Because high concentrations of barite and other deposited solids, such as solids 22, may be present on or near the base of tank 10, sprayer device 30 can be oriented in a manner that focuses the spray pattern of sprayer device 30 (and spray nozzles 33, 34 and 35) toward the lower portion of tank 10.

As wash water 41 is sprayed inside tank 10 using sprayer device 30, such wash water 41 can build up or accumulate inside tank 10. Further, solid debris (such as, for example, barite, bentonite or other drilling fluid residue), can become suspended in such wash water 41. Accordingly, in the preferred embodiment, high-rate submergible pump 50 is placed within tank 10 in order to remove accumulated wash water 41, as well as any accompanying solids suspended in or otherwise carried by such wash water. Although pump 50 can be installed in any number of manners, in the preferred embodiment said pump 50 is attached to a conduit, such as hose 51, and suspended within tank 10 via tank access hatch 11. In the preferred embodiment, such pump 50 is positioned at or near the base of tank 10 in order to beneficially draw from lower levels of the tank. In this position, pump 50 can draw from deposited solids 22 at or near the base of tank 10, as well as wash water 41.

Wash water 41, and any accompanying solids, are pumped from tank 10 using high rate submergible pump 50 and directed to separator unit 60 via hose 51. In the preferred embodiment, separator unit 60 is a vessel having segregated compartments 61 and 62 that are separated by baffle assembly 63. Solids 23, which are suspended in or otherwise carried by wash water 41 entering separator unit 60 fall to the bottom of such separator unit and remain within compartment 61, while relatively solid-free wash water 41 passes into compartment 62 over baffle assembly 63. Separated solids 23 can be removed from compartment 61 and loaded into boxes or other containers for disposal (or transportation to an off-site disposal facility).

Recovered wash water 41 is directed from segregated compartment 62 of separator unit 60 to reservoir 40 via a conduit, such as hose 52. Such recovered wash water 41 is pumped from reservoir 40 into tank 10, and the process is repeated. In this manner, such wash water 41 is recycled and reused as part of a “closed-loop” system, thereby reducing the overall amount of wash fluid needed (as well as waste material that must transported to an off-site facility for disposal).

In the preferred embodiment, at least one chemical agent or other beneficial additive can be added to wash water 41. Although such chemical agent can be added any number of different ways, in the preferred embodiment, such chemical additive is added to wash water 41 using a chemical injection pump to be sprayed within tank 10. Such chemical agent(s) promote solids dropping out of suspension, thereby allowing solids and liquids to more readily separate within separator unit 60, which in turn improves the overall performance of separator unit 60.

In the preferred embodiment of the present invention, a chemical additive to be added to wash water 41 is a beneficial surfactant solution. Such surfactant solution is added to the wash water 41 and is selected from a range of chemical compounds known to be effective in removing drilling fluids from hard metal surfaces. Depending. upon whether the drilling fluid previously contained within tank 10 is water-based, diesel-based or one of many synthetic oil-based varieties, alterations can be made to the surfactant solution to optimize efficiency and effectiveness of the cleaning process.

In the preferred embodiment, the surfactant solution should be designed with the following physical characteristics:

1. It should be able to coat the surface area of the barite or other solid component material of the drilling fluid in order to create lubricity for ease of pumping.

2. It should not strip hydrocarbons from the solid component material of the drilling fluid, which would be creating an unwanted and difficult to break oil-in-water emulsion in the wash water/surfactant solution;

3. It should allow for suspension of the solids into the wash water solution long enough for the solids to be pumped into the separation unit. Thereafter, the properly balanced wash water/surfactant solution must separate solids from the liquid medium. Solids accumulate at the bottom of the separator unit, but remain in a form that can be easily pumped or otherwise transferred into disposal containers. The wash water/surfactant solution minus the solids, and with minimal to no oil in the liquid medium, is directed back to the tank being cleaned;

4. It should be recyclable and reusable until all tanks (or, in marine applications) the entire vessel being cleaned is deemed completed by a qualified inspector.

5. It should preclude “redeposition” of solids onto the walls or floors of tanks being cleaned; and

6. It should be able to be used in small percentage of total volume of a wash water/surfactant package/solids mixture in order to remain economically viable. In the preferred embodiment, the surfactant package should be used in an amount equal to or less than a three percent (3%) strength of the entire liquid/solid mixture.

As water containing surfactant solution is cycled through the aforementioned process, effluent fluid pumped from the tank being cleaned carries progressively less solids. The longer that the process is allowed to continue, the cleaner a particular tank will become. Further, the cleaning progress can be judged or evaluated by examining the effluent stream leaving such tank.

FIG. 2 depicts a side view of a prior art sprayer device 30 of the present invention. Said sprayer device 30 generally comprises substantially cylindrical body 36, inlet 37 and swivelled head 38. Nozzles 33, 34 and 35 are disposed swivelled head 38. Sprayer device 30 is well known in the art.

Fluid, such as wash water 41, is pumped into inlet 37. Such fluid passes through sprayer device 30 until it is discharged through nozzles 33, 34 and 35. Swivelled head 38 can spin, thereby permitting nozzles 33, 34 and 35 to be oriented in multiple different directions during the spraying process.

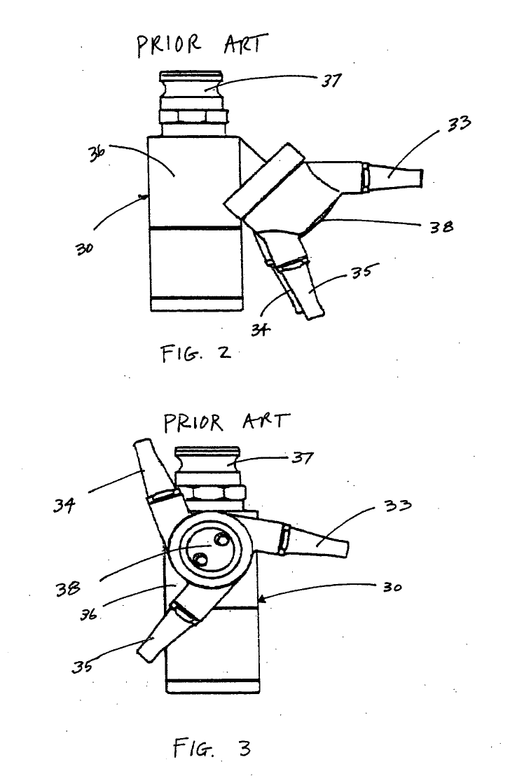

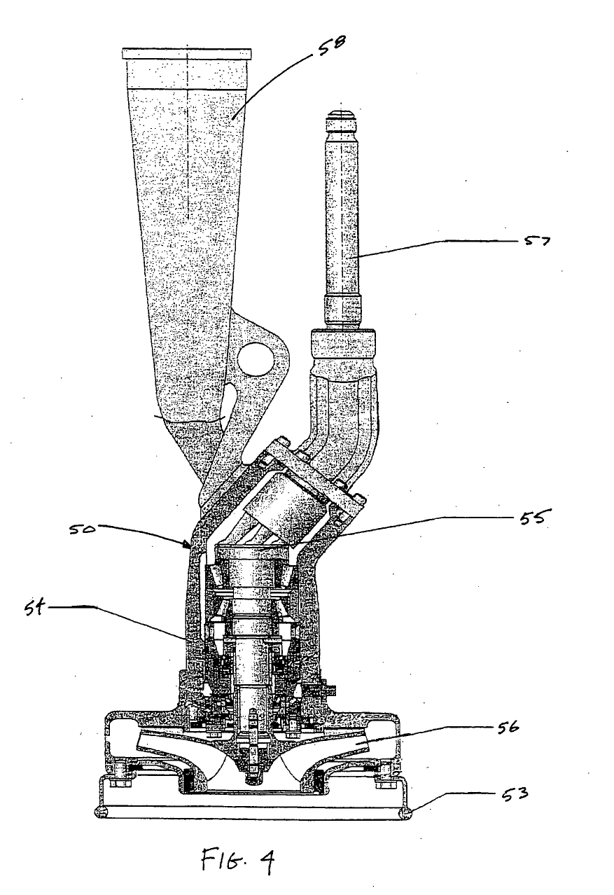

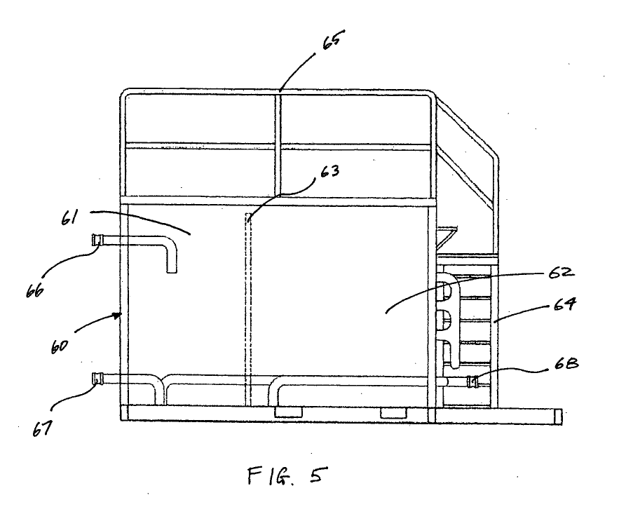

FIG. 3 depicts an alternative embodiment of sprayer device 30 of the present invention. Nozzles 33, 34 and 35 are oriented differently than as depicted in FIG. 4. By alternating the configuration of the nozzles attached to sprayer device 30, as well as the location of sprayer device 30 relative to the inside of an enclosure to be cleaned, overall efficiency and effectiveness of the spraying process can be improved.

FIG. 4 depicts a cut-away view of a prior art high-rate submergible pump 50 of the present invention. Said submergible pump 50, which is generally capable of pumping large volumes of fluid at high rates, including fluids containing large amounts of suspended solids, generally comprises support base 53 defining an input port, pump housing 54, hydraulic motor 55, impeller 56, hydraulic line 57 and outport port 58. Fluids, such as wash water 41 containing solids, such as solids 22 from tank 10, are pumped into the inlet port of submergible pump 50 and discharged via output port 58.

FIG. 5 depicts a cut-away view of a separator unit 60 of the present invention. In the preferred embodiment, separator unit 60 comprises compartments 61 and 62, separated by baffle assembly 63. Beneficial steps 64 and hand-rail 65 are provided to assist operator access to separator unit 60. Inlet line 66 leads into the upper portion of compartment 61, while solid withdrawal line 67 leads into the base of compartment 61. Outlet line 68 extends from the base of compartment 62.

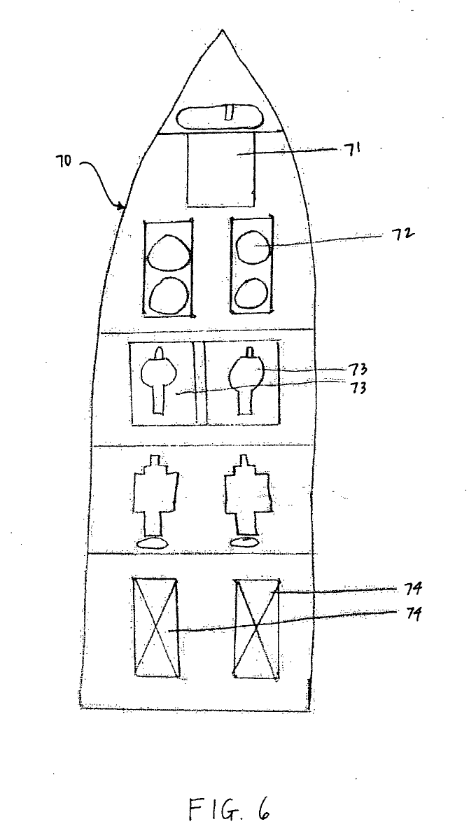

FIG. 6 depicts an overhead schematic view of a marine mobile cleaning apparatus 70 of the present invention. As set forth above, in many applications, tanks to be cleaned are situated on drilling rigs or boats, or in other marine environments. As such, it is often advantageous to utilize the cleaning apparatus of the present invention in connection with a marine vessel. In such instances, the marine mobile cleaning apparatus of the present invention can quickly and effectively move to the location where such tanks are located. Tanks can be cleaned as set forth in detail herein, and the marine mobile cleaning apparatus can thereafter leave such location after completion of the job.

Because substantially all of the large equipment associated with the present invention can be incorporated directly on marine mobile cleaning apparatus 70, relatively little equipment must be transferred over to the rig, boat or other facility housing the tank(s) to be cleaned. As such, mobilization and demobilization time is greatly reduced. Further, valuable deck space, which is at a premium on boats, rigs, docks or other facilities, can be conserved.

Referring to FIG. 6, in the preferred embodiment marine mobile cleaning apparatus 70 comprises separator unit 71, solid storage containers 72, fluid pumps 73, and storage tanks 74.

In accordance with the description set forth above, marine mobile cleaning apparatus 70 is moved in proximity to a vessel or rig containing tanks to be cleaned. Once said mobile marine cleaning apparatus is properly situated, at least one sprayer device is beneficially mounted within the confines of a tank to be cleaned. Although said sprayer device can be mounted within such tank using any number of different methods, in the preferred embodiment sprayer device is mounted to an internal surface of tank using adjustable magnetic mounts.

Wash water or other beneficial fluid or chemical additive(s) is then pumped through a conduit into such sprayer device using fluid pumps 73. In the preferred embodiment, wash water is discharged through nozzles of the sprayer device at high velocity in desired direction(s) within the tank to be cleaned in order to wash the interior surfaces of such tank.

In the preferred embodiment, a high-rate submergible pump is placed within a tank to be cleaned in order to remove accumulated wash water, as well as any accompanying solids suspended in or otherwise carried by such wash water. Wash water, and any accompanying solids, are pumped from the tank to be cleaned using high rate submergible pump and directed to separator unit 71 situated on marine mobile cleaning apparatus 70. In the preferred embodiment, separator unit 71 is a vessel having segregated compartments separated by baffle assembly much like separator unit 60 described above.

Recovered wash water is directed from separator unit 71 to reservoir, such as storage tank 74. Recovered wash water is in turn pumped from storage tank 74 into the tank to be cleaned, and the process is repeated. In this manner, wash water is recycled and reused as part of a “closed-loop” system, thereby reducing the overall amount of wash fluid needed (as well as waste material that must transported to an off-site facility for disposal).

Whereas the invention is herein described with respect to a preferred embodiment, it should be realized that the above described and other various changes may be made without departing from the essential contributions to the art made by teachings hereof.

What is claimed:

1. An apparatus for cleaning interior surfaces of an enclosure comprising:
a. a first pump, disposed within the enclosure, having an inlet and an outlet;
b. a separator vessel having an inlet and an outlet;
c. a first conduit connecting the outlet of said first pump to the inlet of said separator vessel;
d. a second pump having an inlet and an outlet;
e. a second conduit connecting the outlet of said separator vessel to the inlet of said second pump;
f. a sprayer, disposed within the enclosure, having an inlet and at least one nozzle; and
g. a third conduit connecting the outlet of said second pump to the inlet of said sprayer.

2. The apparatus of claim 1, further comprising means for adjustably mounting said sprayer to an internal surface of said enclosure;

3. The apparatus of claim 2, wherein said means for adjustably mounting said sprayer comprises at least one magnetic mount.

4. The apparatus of claim 1, wherein said first pump is a submergible pump.

5. The apparatus of claim 1, wherein said at least one nozzle of said sprayer is disposed on a swivelled head.

6. The apparatus of claim 1, wherein said first, second and third conduits are flexible hoses.

7. The apparatus of claim 1, wherein said separator vessel further comprises:
a. a first compartment;
b. a second compartment; and
c. a baffle assembly separating said first and second compartments.

8. The apparatus of claim 1, wherein said first pump and separator vessel are disposed on a marine vessel.

9. An apparatus for cleaning interior surfaces of an enclosure comprising:
a. a submergible pump, disposed within the enclosure, having an inlet and an outlet;
b. a separator vessel having an inlet, an outlet and at least two compartments, wherein said compartments are separated by a baffle assembly;
c. a first conduit connecting the outlet of said submergible pump to the inlet of said separator vessel;
d. a second pump having an inlet and an outlet;
e. a second conduit connecting the outlet of said separator vessel to the inlet of said second pump;
f. a sprayer, disposed within the enclosure, having an inlet and at least one nozzle;
g. at least one magnetic mount connecting said sprayer to an interior surface of said enclosure; and
h. a third conduit connecting the outlet of said second pump to the inlet of said sprayer.

10. The apparatus of claim 9, wherein said at least one nozzle of said sprayer is disposed on a swivelled head.

11. The apparatus of claim 9, wherein said first, second and third conduits are flexible hoses.

12. The apparatus of claim 9, wherein said second pump and separator vessel are mounted on a marine vessel.

13. An apparatus for cleaning interior surfaces of an enclosure comprising:
a. a submergible pump, disposed within the enclosure, having an inlet and an outlet;
b. a separator vessel having an inlet, an outlet and at least two compartments, wherein said compartments are separated by a baffle assembly;
c. a first conduit connecting the outlet of said submergible pump to the inlet of said separator vessel;
d. a fluid reservoir having an inlet and an outlet;
e. a second conduit connecting the outlet of said separator vessel to the inlet of said fluid reservoir;
f. a second pump having an inlet and an outlet;
g. a third conduit connecting the outlet of said fluid reservoir to the inlet of said second pump;
h. a sprayer, disposed within the enclosure, having an inlet and at least one nozzle;
i. at least one magnetic mount connecting said sprayer to an interior surface of said enclosure; and
j. a fourth conduit connecting the outlet of said second pump to the inlet of said sprayer.

14. The apparatus of claim 13, wherein said at least one nozzle of said sprayer is disposed on a swivelled head.

15. The apparatus of claim 13, wherein said first, second, third and fourth conduits are flexible hoses.

16. The apparatus of claim 13, wherein said second pump and separator vessel are mounted on a marine vessel.

17. The apparatus of claim 16, wherein said fluid reservoir is mounted on a marine vessel.

18. A method of cleaning debris from internal surfaces of an enclosure comprising:
a. Spraying wash fluid within said enclosure;
b. Pumping said wash fluid and debris from said enclosure;
c. Separating said debris from said wash fluid; and
d. Re-spraying said separated wash fluid within said enclosure.

19. The method of claim 18, wherein said wash fluid comprises a surfactant solution.
